(19) United States
(12) Patent Application Publication
(10) Pub. No.: US 2023/0199276 A1
(43) Pub. Date: Jun. 22, 2023

(54) AUDIOVISUAL CONTENT ACCESS FACILITATION SYSTEM AND METHOD INCORPORATING ARTIFICIAL INTELLIGENCE

(71) Applicants: Jeffrey Paul, Plainfield, NJ (US); Steven Glen Durham, New York, NY (US); Ryan Paul, Plainfield, NJ (US); Michael Puscar, Rionegro (CO)

(72) Inventors: Jeffrey Paul, Plainfield, NJ (US); Steven Glen Durham, New York, NY (US); Ryan Paul, Plainfield, NJ (US); Michael Puscar, Rionegro (CO)

(21) Appl. No.: 17/386,105

(22) Filed: Jul. 27, 2021

Related U.S. Application Data
(60) Provisional application No. 63/057,360, filed on Jul. 28, 2020.

(51) Int. Cl. H04N 21/84; G06F 16/78; G06F 16/68

(52) U.S. Cl. CPC H04N 21/84; G06F 16/7867; G06F 16/686

(57) ABSTRACT

A system for facilitating access to audiovisual content in which a content obtaining unit is configured to obtain a content source (e.g., a computer-readable file containing audiovisual content of a conference, lecture, or entertainment program); a descriptor obtaining unit is configured to obtain one or more descriptors (e.g., topic and speaker taxonomies and attributes associated with the content); a conversion unit configured to convert content of the content source from a format less efficient for categorization (e.g., video with audio) to a format more efficient for categorization (e.g., a textual transcription of the audio and/or a textual description of the video); a categorization unit configured to categorize the converted content into at least two categories based on the one or more descriptors (e.g., into one or more topics, and/or one or more speakers); and a presentation unit configured to present a category selection interface (e.g., an actionable table of contents) based on the at least two categories. In preferred embodiments, the conversion unit utilizes an artificial intelligence conversion algorithm, a transcription algorithm, a description algorithm, and/or user interaction. Further in preferred embodiments, the categorization unit utilizes an artificial intelligence categorization algorithm, a topic extraction algorithm, a speaker diarization algorithm, a semantic web technology algorithm, and/or user interaction.

### BACKGROUND OF THE INVENTION

### 1. Field of the Invention

The present general inventive concept relates to audiovisual content recognition systems and methods, and more particularly, to an audiovisual content access facilitation system and method incorporating artificial intelligence.

### 2. Description of Related Art

Audio and video content in numerous fields is readily available to users through their own media storage systems as well as through company intranets and various Internet-based services. With some exceptions, the audio and video content rarely has an accompanying or easily accessible transcript or detailed description. Accordingly, unless a user listens to an entire audio presentation or watches an entire video presentation, it is difficult for the user to know any detail regarding the content of the presentation, much less search the content for any specific information sought by the user.

Closed captioning, which involves transcribing speech in an audiovisual presentation into text and encoding the text within the video content of the presentation for viewing concurrently with the audio content, can be used to assist hearing-impaired viewers or viewers requiring a quiet environment in understanding speech uttered in the audiovisual presentation. However, implementation of closed captioning is time consuming and requires specialized systems. Further, most audiovisual content lacks closed captioning.

Absent any transcript or detailed description that links the information covered to specific timepoints in an audio or video presentation, navigation of the audio or video presentation to find topics or speakers of interest is extremely difficult for users who are not professional video editors. While users can review audio and video content, transcribe or summarize the content, and match the transcribed or summarized content to a timeline of the content playback, such efforts are extremely time consuming and accordingly too expensive for most instances in which users want to understand and search the content.

Accordingly, what is needed is a system that quickly and easily categorizes, organizes, and contextualizes content from audiovisual presentations. Further, what is needed is a system that enables users to quickly and easily understand, browse, search, navigate, and share content from audiovisual presentations.

### SUMMARY OF THE INVENTION

The present general inventive concept provides an audiovisual content access facilitation system and method incorporating artificial intelligence, which addresses the above mentioned shortcomings by meeting the above described needs.

### General Overview

The present general inventive concept relates to a system and method for generating a category selection interface for audiovisual content. Preferably, the system and method are implemented with computer hardware and software, utilizing artificial intelligence, topic extraction, transcription, speaker diarization, semantic web, and/or user interaction technologies to generate an actionable table of contents for audio content and/or video content that allows users to quickly categorize, organize, and contextualize content of the audio content and/or video content, and to understand, browse, search, navigate, and share the content.

Certain embodiments of the present invention include a computing device that includes one or more processors, one or more memories, and one or more computer-readable hardware storage devices. The one or more computer-readable hardware storage devices contain program code executable by the one or more processors via the one or more memories to implement a method for generating an actionable table of contents for audio content and/or video content.

Further in certain embodiments, the method includes receiving the content from a content source, which can be obtained locally or from a network. As examples, the content can be associated with a conference, a lecture, a panel discussion, a documentary, an educational lesson, or an entertainment purpose. The method preferably includes then receiving, locally or from a network, one or more taxonomies, which can include a speaker and a topic of the content, and/or one or more attributes associated with the content. The method further preferably includes then utilizing a transcription algorithm to transcribe audio from the content into a textual format and categorizing the textual format of the content into at least two sections based on the taxonomies and/or attributes. When the taxonomies include the topic, the separation of the textual format preferably is accomplished by an artificial intelligence algorithm and/or a topic extraction algorithm. When the taxonomies include the speaker, the separation of the textual format preferably is accomplished by speaker diarization technology.

Preferably, each of the sections is tagged with the speaker and/or the topic. Preferably, a unique biometric profile of the voice of the speaker and/or the topic is stored in association with each of the sections.

Further in certain embodiments, the method includes then generating an actionable table of contents for the content based on the sections. The actionable table of contents is preferably displayed to the user via a graphical user interface (GUI). Preferably, the method further includes prompting the user, preferably in real-time, to provide feedback regarding the actionable table of contents, and in response to receiving the feedback, training the system based on the feedback.

Accordingly, the present invention provides at least several benefits and objectives. The invention provides a computer system for generating an actionable table of contents for audio content and/or video content, utilizing artificial intelligence, topic extraction, transcription, speaker diarization, semantic web, and/or user interaction technologies, that allows users to quickly categorize, organize, and contextualize portions of the content and to understand, browse, search, navigate, and share the content.

### Summary of System Embodiments

In preferred embodiments of the present general inventive concept, a system for facilitating access to audiovisual content includes a content obtaining unit configured to obtain a content source; a descriptor obtaining unit configured to obtain one or more descriptors; a conversion unit configured to convert content of the content source from a format less efficient for categorization to a format more efficient for categorization; a categorization unit configured to categorize the converted content into at least two categories based on the one or more descriptors; and a presentation unit configured to present a category selection interface based on the at least two categories.

In certain embodiments, the content source is a computer-readable file containing one or more of audio content, video content, and audiovisual content. Preferably, the content is associated with one or more of a conference, a lecture, a discussion, a documentary, a lesson, and an entertainment program.

Further in preferred embodiments of the present general inventive concept, the one or more descriptors includes one or more taxonomies. In certain embodiments, the one or more taxonomies includes one or more of a speaker taxonomy and a topic taxonomy.

Further in preferred embodiments of the present general inventive concept, the one or more descriptors includes one or more attributes associated with the content. In certain embodiments, the one or more attributes includes one or more of a timeframe and an amount of time. In certain embodiments, the one or more attributes are associated with the content one or more of automatically or by user interaction. In certain embodiments, the one or more attributes are re-associated with the content after being associated with the content.

Further in preferred embodiments of the present general inventive concept, to convert the content, the conversion unit utilizes one or more of an artificial intelligence conversion algorithm, a transcription algorithm, a description algorithm, and user interaction. In certain embodiments, the artificial intelligence conversion algorithm includes an option for learning by human intervention to enhance accuracy of conversion. In certain embodiments, the transcription algorithm transcribes audio from the content into a textual transcription. Preferably, the transcription includes one or more of phrases, sentences and paragraphs corresponding to the content. Preferably, the transcription algorithm utilizes one or more of Otter, Google Speech-to-Text, and video caption files. In certain embodiments, the description algorithm summarizes video from the content into a textual description.

Further in preferred embodiments of the present general inventive concept, the categorization unit further categorizes the converted content into at least two subcategories under at least one of the at least two categories.

Further in preferred embodiments of the present general inventive concept, to categorize the converted content, the categorization unit utilizes one or more of an artificial intelligence categorization algorithm, a topic extraction algorithm, a speaker diarization algorithm, a semantic web technology algorithm, and user interaction. In certain embodiments, the artificial intelligence categorization algorithm includes an option for learning by human intervention to enhance accuracy of categorization.

In certain embodiments, the artificial intelligence categorization algorithm creates a respective vector for one or more portions of the converted content, inputs each vector into a recurrent neural network to determine a respective numerical value associated with each vector, determines breakpoints from the numerical values, and establishes the breakpoints as divisions between the categories.

In certain embodiments, the topic extraction algorithm inputs one or more portions of the converted content into a meaning vector space to determine meaning vectors for each portion, and inputs the meaning vectors into a deep neural network to select one or more of a plurality of topics.

In certain embodiments, the semantic web technology algorithm inputs one or more portions of the converted content into a titling modeler to determine titles for each portion, and the presentation unit presents one or more of the titles in the category selection interface.

In certain embodiments, the one or more of the descriptors includes at least one of one or more taxonomies and one or more attributes associated with the content. Preferably, the one or more taxonomies includes one or more of a topic taxonomy and a speaker taxonomy.

Further preferably, when the one or more taxonomies includes a speaker taxonomy, the categorization unit tags and stores for each speaker associated with the content a respective profile for the speaker, and when the one or more taxonomies includes a topic taxonomy, the categorization unit tags and stores for each topic associated with the content a respective profile for the topic.

Further preferably, when the one or more taxonomies includes a topic taxonomy, the categorization unit utilizes one or more of the artificial intelligence categorization algorithm and the topic extraction algorithm.

Further preferably, when the one or more taxonomies includes a speaker taxonomy, the categorization unit utilizes the speaker diarization algorithm. Still further preferably, the speaker diarization algorithm searches one or more of local storage and network storage.

Further in preferred embodiments of the present general inventive concept, the selection interface includes an actionable table of contents for the content. In certain embodiments, the table of contents includes entries that at least one of summarize and contextualize the content. In certain embodiments, the table of contents enables a user to at least one of browse and search the content by the one or more descriptors. In certain embodiments, the table of contents enables a user to share at least a portion of each of the at least two categories with another user. In certain embodiments, the table of contents enables a user to provide feedback regarding the table of contents. Preferably, the feedback is used to train the system to apply the feedback in subsequent processing.

In certain embodiments, the table of contents includes, for each category, at least one of a respective category title and a respective category concept, each of which can be selected to transport presentation of the content to a corresponding respective presentation category timepoint. Preferably, the table of contents further includes, for each of a plurality of subcategories under each category, at least one of a respective subcategory title and a respective subcategory concept, each of which can be selected to transport presentation of the content to a corresponding respective presentation subcategory timepoint.

In certain embodiments, the table of contents includes a textual representation of the content, and as the content is presented, during each content presentation timeframe corresponding to a respective portion of the textual representation, the presentation of the respective portion of the textual representation is enhanced relative to other portions of the textual representation. Preferably, the textual representation is one or more of a textual transcription of audio from the content and a textual description of video from the content. Preferably, the textual representation includes, for each category, at least one of a respective category title and a respective category concept. Further preferably, the textual representation further includes, for each of a plurality of subcategories under each category, at least one of a respective subcategory title and a respective subcategory concept.

### Summary of Method Embodiments

In other preferred embodiments of the present general inventive concept, a method of facilitating access to audiovisual content includes obtaining a content source; obtaining one or more descriptors; converting content of the content source from a format less efficient for categorization to a format more efficient for categorization; categorizing the converted content into at least two categories based on the one or more descriptors; and presenting a category selection interface based on the at least two categories.

Further in other preferred embodiments of the present general inventive concept, converting the content includes utilizing one or more of an artificial intelligence conversion algorithm, a transcription algorithm, a description algorithm, and user interaction. In certain embodiments, utilizing the artificial intelligence conversion algorithm includes learning by human intervention to enhance accuracy of conversion. In certain embodiments, utilizing the transcription algorithm includes transcribing audio from the content into a textual transcription. In certain embodiments, utilizing the description algorithm includes summarizing video from the content into a textual description.

Further in other preferred embodiments of the present general inventive concept, the method further comprises categorizing the converted content into at least two subcategories under at least one of the at least two categories.

Further in other preferred embodiments of the present general inventive concept, categorizing the converted content includes utilizing one or more of an artificial intelligence categorization algorithm, a topic extraction algorithm, a speaker diarization algorithm, a semantic web technology algorithm, and user interaction. In certain embodiments, utilizing the artificial intelligence categorization algorithm includes learning by human intervention to enhance accuracy of categorization.

In certain embodiments, utilizing the artificial intelligence categorization algorithm includes creating a respective vector for one or more portions of the converted content, inputting each vector into a recurrent neural network to determine a respective numerical value associated with each vector, determining breakpoints from the numerical values, and establishing the breakpoints as divisions between the categories.

In certain embodiments, utilizing the topic extraction algorithm includes inputting one or more portions of the converted content into a meaning vector space to determine meaning vectors for each portion, and inputting the meaning vectors into a recurrent neural network to establish start and stop points of the converted content for each of a plurality of topics.

In certain embodiments, utilizing the semantic web technology algorithm includes inputting one or more portions of the converted content into a titling modeler to determine titles for each portion, and presenting the category selection interface includes presenting one or more of the titles.

In certain embodiments, the one or more of the descriptors includes at least one of one or more taxonomies, and the method further comprises, when the one or more taxonomies includes a speaker taxonomy, tagging and storing for each speaker associated with the content a respective profile for the speaker, and further comprises, when the one or more taxonomies includes a topic taxonomy, tagging and storing for each topic associated with the content a respective profile for the topic.

Preferably, the method further comprises, when the one or more taxonomies includes a topic taxonomy, utilizing one or more of the artificial intelligence categorization algorithm and the topic extraction algorithm.

Preferably, the method further comprises, when the one or more taxonomies includes a speaker taxonomy, utilizing the speaker diarization algorithm.

Further in other preferred embodiments of the present general inventive concept, the selection interface includes an actionable table of contents for the content. In certain embodiments, presenting the table of contents includes at least one of summarizing and contextualizing the content. In certain embodiments, presenting the table of contents includes enabling a user to at least one of browse and search the content by the one or more descriptors. In certain embodiments, presenting the table of contents includes enabling a user to share at least a portion of each of the at least two categories with another user. In certain embodiments, presenting the table of contents includes enabling a user to submit feedback regarding the table of contents. Preferably, the method further comprises using the feedback to train the system to apply the feedback in subsequent processing.

In certain embodiments, presenting the table of contents includes, for each category, presenting at least one of a respective category title and a respective category concept, each of which can be selected to transport presentation of the content to a corresponding respective presentation category timepoint. Preferably, presenting the table of contents further includes, for each of a plurality of subcategories under each category, presenting at least one of a respective subcategory title and a respective subcategory concept, each of which can be selected to transport presentation of the content to a corresponding respective presentation subcategory timepoint.

In certain embodiments, presenting the table of contents includes presenting a textual representation of the content, and as the content is presented, during each content presentation timeframe corresponding to a respective portion of the textual representation, the presentation of the respective portion of the textual representation is enhanced relative to other portions of the textual representation.

Additional features and embodiments of the present general inventive concept will be apparent from the following detailed description, drawings, and claims.

### BRIEF DESCRIPTION OF THE FIGURES

The following example embodiments are representative of example techniques and structures designed to carry out the objects of the present general inventive concept, but the present general inventive concept is not limited to these example embodiments. In the accompanying drawings and illustrations, the sizes and relative sizes, shapes, and qualities of lines, entities, and regions may be exaggerated for clarity. A wide variety of additional embodiments will be more readily understood and appreciated through the following detailed description of the example embodiments, with reference to the accompanying drawings in which:

FIG. 1 illustrates with a block diagram an example system of a preferred embodiment of the present general inventive concept, configured to generate a category selection interface for audiovisual content.

FIG. 2 illustrates with a block diagram an example computing device for use in the system of FIG. 1.

FIG. 3 illustrates with a block diagram an example category selection interface presented by the system of FIG. 1.

FIG. 4 illustrates with a block diagram the example computing device of FIG. 2 integrated with the system of FIG. 1.

FIG. 5 illustrates a method of facilitating access to audiovisual content.

### DETAILED DESCRIPTION OF PREFERRED EMBODIMENTS

Reference will now be made to preferred embodiments of the present general inventive concept, examples of which are illustrated in the accompanying drawings and illustrations. The example embodiments are described herein in order to explain the present general inventive concept by referring to the figures.

The following detailed description is provided to assist the reader in gaining a comprehensive understanding of the structures and methods described herein. Accordingly, various changes, modifications, and equivalents of the structures and methods described herein will be suggested to those of ordinary skill in the art. The progression of method operations described are merely examples, however, and the sequence type of operations is not limited to that set forth herein and may be changed as is known in the art, with the exception of operations necessarily occurring in a certain order. Also, descriptions of well-known functions and construction methods may be simplified and/or omitted for increased clarity and conciseness.

Numerous variations, modifications, and additional embodiments are possible, and accordingly, all such variations, modifications, and embodiments are to be regarded as being within the spirit and scope of the present general inventive concept. For example, regardless of the content of any portion of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity may be repeated, any activity may be performed by multiple entities, and/or any element may be duplicated. In addition, the sizes, shapes and configurations of the various structures and elements may vary in order to perform specific functions as necessary for a particular implementation.

### Overview of Preferred Embodiments

The present general inventive concept provides an audiovisual content access facilitation system and method incorporating artificial intelligence.

### Detailed Description of Certain System Embodiments

In preferred embodiments of the present general inventive concept, a system for facilitating access to audiovisual content includes a content obtaining unit configured to obtain a content source; a descriptor obtaining unit configured to obtain one or more descriptors; a conversion unit configured to convert content of the content source from a format less efficient for categorization to a format more efficient for categorization; a categorization unit configured to categorize the converted content into at least two categories based on the one or more descriptors; and a presentation unit configured to present a category selection interface based on the at least two categories.

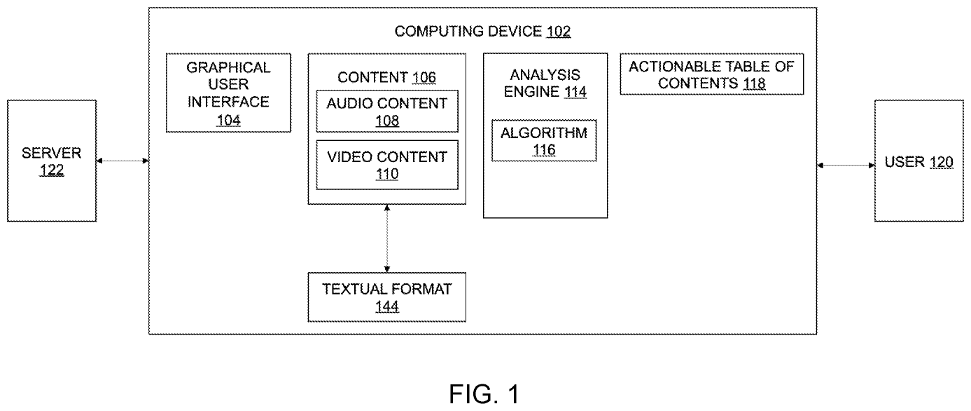

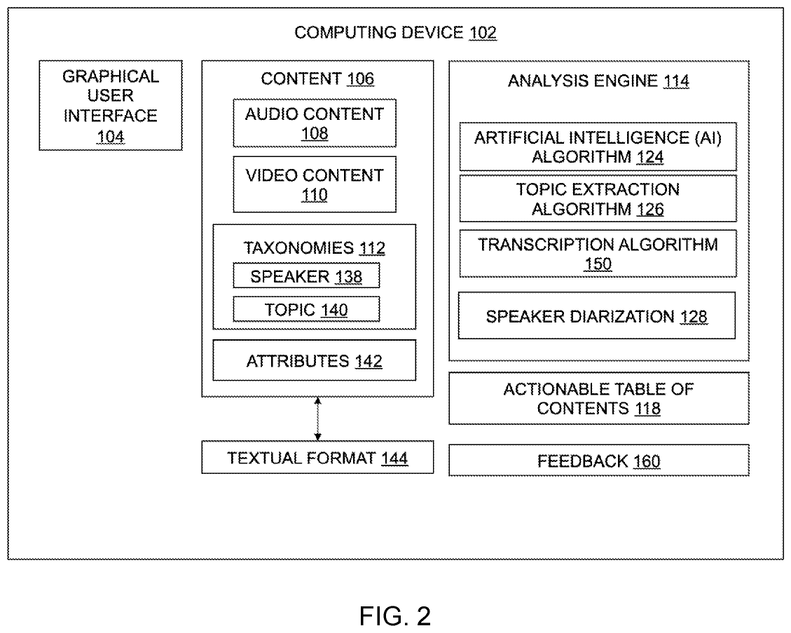

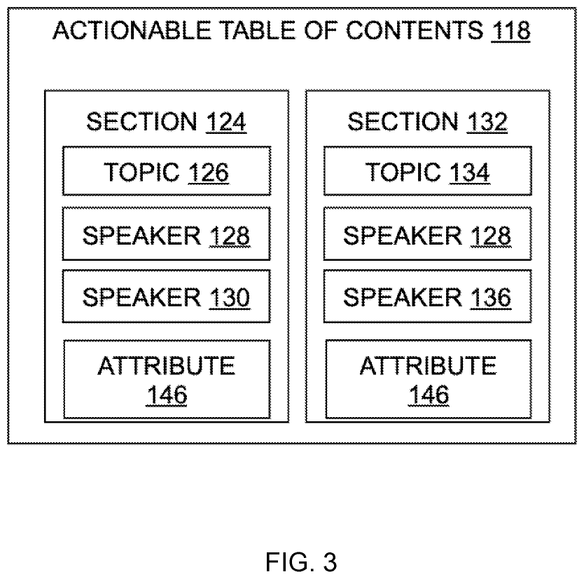

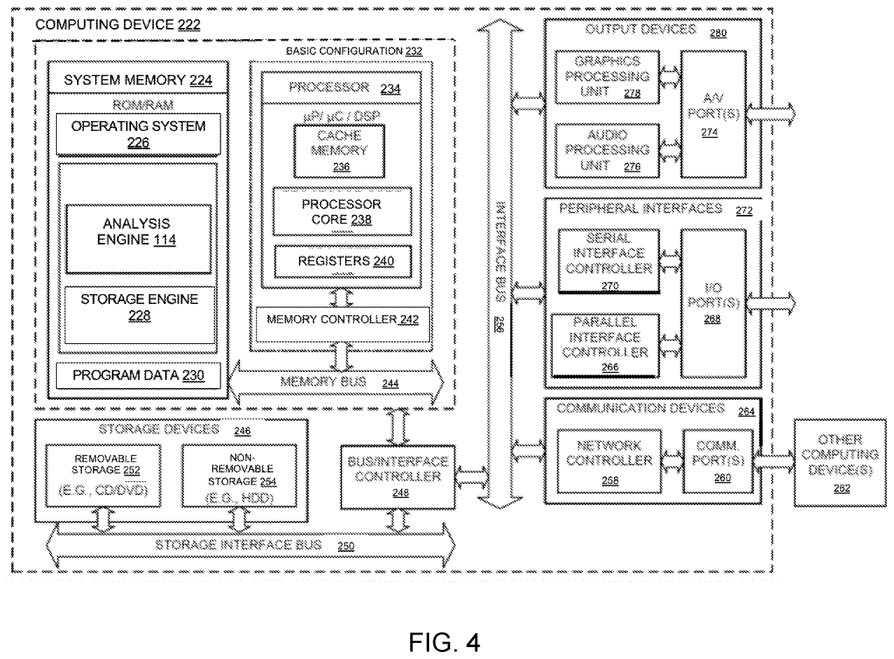

Referring now to FIGS. 1-4, aspects of an example system of a preferred embodiment of the present general inventive concept are illustrated. FIG. 1 illustrates with a block diagram the example system. FIG. 2 illustrates with a block diagram an example computing device for use in the example system. FIG. 3 illustrates with a block diagram an example category selection interface presented by the example system. FIG. 4 illustrates with a block diagram the example computing device integrated with the example system.

The system may include a computing device 102 (see, e.g., FIGS. 1 and 2). The computing device 102 may be a desktop computer, a laptop computer, a smartphone (e.g., an iPhone®, a Blackberry®, or an Android OS-based phone, etc.), a tablet computer (e.g., an Apple iPad™, an HP Slate™, or a Motorola Xoom™, etc.), or an eBook reader (e.g., an Amazon Kindle™ or Barnes and Noble's Nook™ eReader, etc.), among other examples not explicitly listed herein. The computing device 102 may interact with a server 122 (see, e.g., FIG. 1) via a network.

The computing device 102 may include an analysis engine 114 (see, e.g., FIGS. 1, 2 and 4). The analysis engine 114 may be implemented by hardware, software, or a combination of hardware and software. The hardware can be general computing hardware or specialized computing hardware. The software can be general computing software configured to carry out the functions described herein in cooperation with the hardware, such that the analysis engine 114 is actually and functionally a machine capable of carrying out the functions described herein. The software can alternatively be specialized computing software configured to carry out the functions described herein in cooperation with the hardware, such that the analysis engine 114 is actually and functionally a machine capable of carrying out the functions described herein. Accordingly, the analysis engine 114 may be or include an application, a software program, a service, or a software platform that is configured to be executable on the computing device 102.

Preferably, the analysis engine 114 includes the content obtaining unit, the descriptor obtaining unit, the conversion unit, the categorization unit, and the presentation unit, all of which are implemented by hardware, software, or a combination of hardware and software as discussed above.

The computing device 102 may include a graphical user interface (GUI) 104 (see, e.g., FIGS. 1 and 2) such that a user 120 may interact with the analysis engine 114 via the GUI 104. For example, the category selection interface (e.g., actionable table of contents 118) can be displayed on the GUI 104.

Preferably, the content obtaining unit of the analysis engine 114 obtains the content source. The content source can be obtained from the user 120 or another person or machine, locally or via the network. In preferred embodiments of the present general inventive concept, the content source is a computer-readable file containing one or more of audio content 108, video content 110, and audiovisual content (e.g., the video content 110 can include the audio content 108). Preferably, the content 106 is associated with one or more of a conference, a lecture, a discussion, a documentary, a lesson, and an entertainment program.

Preferably, the descriptor obtaining unit of the analysis engine 114 obtains the descriptors. In preferred embodiments of the present general inventive concept, the one or more descriptors includes one or more taxonomies 112. In certain embodiments, the one or more taxonomies includes one or more of a speaker taxonomy 138 and a topic taxonomy 140. Further in preferred embodiments of the present general inventive concept, the one or more descriptors includes one or more attributes 142 associated with the content. In certain embodiments, the one or more attributes includes one or more of a timeframe (e.g., a timeframe during which a speaker is speaking) and an amount of time. In certain embodiments, the one or more attributes 142 are associated with the content one or more of automatically or by user interaction (e.g., assigned by the user 120). In certain embodiments, the one or more attributes 142 are re-associated with the content after being associated with the content (e.g., the one or more attributes may be re-assigned to generate the category selection interface).

Preferably, the one or more taxonomies includes a master taxonomy that is created automatically using a Sibling Corporal Indexing (SCI) algorithm. Further preferably, the master taxonomy is enhanced with third party taxonomies, which are then integrated into the master taxonomy. Further preferably, the one or more taxonomies may be appended or modified by a user based on the content being reviewed by the user.

Preferably, the conversion unit of the analysis engine 114 converts the content of the content source from a format less efficient for categorization (e.g., video with audio) to a format more efficient for categorization (e.g., a textual transcription of the audio and/or a textual description of the video). In preferred embodiments of the present general inventive concept, to convert the content, the conversion unit utilizes at least one algorithm 116 (see, e.g., FIG. 1) that can include one or more of an artificial intelligence conversion algorithm, a transcription algorithm 150 (see, e.g., FIG. 3), a description algorithm, and user interaction. It should be understood that the creation of a transcript does not require the presence of descriptors (whether taxonomies, attributes, or other descriptors).

In certain embodiments, the artificial intelligence conversion algorithm includes an option for learning by human intervention to enhance accuracy of conversion. In certain embodiments, the transcription algorithm transcribes audio from the content into a textual transcription 144 (see, e.g., FIGS. 1 and 2). Preferably, the transcription includes one or more of phrases, sentences and paragraphs corresponding to the content. Preferably, the transcription algorithm utilizes one or more of Otter, Google Speech-to-Text, and video caption files. In certain embodiments, the description algorithm summarizes video from the content into a textual description.

Further in preferred embodiments of the present general inventive concept, the categorization unit further categorizes the converted content into at least two subcategories under at least one of the at least two categories.

Preferably, the categorization unit of the analysis engine 114 categorizes the converted content into at least two categories based on the one or more descriptors. For example, the textual transcription 144 is separated into at least two sections (e.g., a first section 124 and a second section 132) based on the one or more taxonomies 112 and/or the one or more attributes 142.

In preferred embodiments of the present general inventive concept, to categorize the converted content, the categorization unit utilizes one or more of an artificial intelligence categorization algorithm 124, a topic extraction algorithm 126, a speaker diarization algorithm 128, a semantic web technology algorithm, and user interaction. In certain embodiments, the artificial intelligence categorization algorithm includes an option for learning by human intervention to enhance accuracy of categorization.

In certain embodiments, the artificial intelligence categorization algorithm creates a respective vector for one or more portions of the converted content, inputs each vector into a recurrent neural network to determine a respective numerical value associated with each vector, determines breakpoints from the numerical values, and establishes the breakpoints as divisions between the categories.

In certain embodiments, the topic extraction algorithm inputs one or more portions of the converted content into a meaning vector space to determine meaning vectors for each portion, and inputs the meaning vectors into a recurrent neural network to establish start and stop points of the converted content for each of a plurality of topics.

In certain embodiments, the semantic web technology algorithm inputs one or more portions of the converted content into a titling modeler to determine titles for each portion, and the presentation unit presents one or more of the titles in the category selection interface.

In certain embodiments, the one or more of the descriptors includes at least one of one or more taxonomies 112 and one or more attributes 142 associated with the content. Preferably, the one or more taxonomies includes one or more of a topic taxonomy 140 and a speaker taxonomy 138.

Further preferably, when the one or more taxonomies includes a speaker taxonomy 138, the categorization unit tags and stores for each speaker associated with the content a respective profile (e.g., a biometric profile) for the speaker, and when the one or more taxonomies includes a topic taxonomy 140, the categorization unit tags and stores for each topic associated with the content a respective profile for the topic. For example, the profiling enables the user 120 to easily jump directly or otherwise navigate to whichever section of the content 106 the user 120 considers the most relevant portion.

Further preferably, when the one or more taxonomies includes a topic taxonomy 140, the categorization unit utilizes one or more of the artificial intelligence categorization algorithm 124 and the topic extraction algorithm 126.

Further preferably, when the one or more taxonomies includes a speaker taxonomy 138, the categorization unit utilizes the speaker diarization algorithm 128. Still further preferably, the speaker diarization algorithm 128 searches one or more of local storage (e.g., local accounts stored on the computing device 102) and network storage (e.g., the Internet via the server 122).

One or more of the algorithms used by the categorization unit preferably utilizes a Sibling Corporal Indexing (SCI) algorithm or an algorithm that functions similarly thereto. The SCI algorithm is configured to process written works (e.g., journal articles and scientific research papers) and use them to build a taxonomy, by utilizing the hierarchical structure of such works and semantic associations. This taxonomy accordingly includes a hierarchically related list of concepts in multiple levels, in which each level of depth represents an additional level of specificity (e.g., Medicine->Oncology->Breast Cancer->Breast Cancer Surgery). Each concept includes a vector of words and weights that uniquely identify the concept and are stored in a database. When the system processes an audiovisual presentation, a transcript is processed using the SCI algorithm, then compared against the word vectors and weights against those within the concept hierarchy by a vector dot product. Any concepts that score higher than a given threshold are identified and associated with the transcript. This classification process is both against the entire transcript as well as each section. When the system detects a major change in the concept space within the transcript, it is an indicator that a new section should be created because the topic has changed in the transcript. Preferably, a phase functioned neural network (PFNN) is configured to take user corrections and feed those back into enhancing the concept classification process and the table of contents creation.

Further in preferred embodiments of the present general inventive concept, the category selection interface includes an actionable table of contents 118 for the content 106. For example, the user 120 can interact with the table of contents 118 to quickly categorize, organize, and contextualize the content 106. In certain embodiments, the table of contents 118 includes entries that at least one of summarize and contextualize the content (e.g., within a designated timeframe). For example, the actionable table of contents 118 is automatically generated for the content 106 based on the at least two sections (e.g., the first section 124 and the second section 132).

In certain embodiments, the table of contents enables a user to at least one of browse and search the content by the one or more descriptors. For example, the actionable table of contents 118 allows the user 120 to quickly search for the first section 124 or the second section 132 by a given topic and/or speaker.

In certain embodiments, the table of contents enables a user to share at least a portion of each of the at least two categories with another user. For example, the actionable table of contents 118 allows the user 120 to share a portion of or the entirety of the first section 124 and/or the second section 132 with another user.

In certain embodiments, the table of contents enables a user to submit feedback regarding the table of contents. For example, the analysis engine 114 may prompt the user 120, in real-time, to submit feedback 160 (see, e.g., FIG. 2) regarding the actionable table of contents 118. The user 120 may submit the feedback 160 via the GUI 104. The feedback 160 may be based on the contextualized phrases generated and/or the textual format. Preferably, the feedback is used to train the system. For example, the user-submitted feedback 160, preferences, and categorizations can be applied in subsequent processing. The user 120 may also interact with the actionable table of contents 118 to generate custom training programs for employees, partners, and others.

In certain embodiments, the table of contents includes, for each category, at least one of a respective category title and a respective category concept, each of which can be selected to transport presentation of the content to a corresponding respective presentation category timepoint. Preferably, the table of contents further includes, for each of a plurality of subcategories under each category, at least one of a respective subcategory title and a respective subcategory concept, each of which can be selected to transport presentation of the content to a corresponding respective presentation subcategory timepoint.

In certain embodiments, the table of contents includes a textual representation of the content, and as the content is presented, during each content presentation timeframe corresponding to a respective portion of the textual representation, the presentation of the respective portion of the textual representation is enhanced relative to other portions of the textual representation. Preferably, the textual representation is one or more of a textual transcription of audio from the content and a textual description of video from the content. Preferably, the textual representation includes, for each category, at least one of a respective category title and a respective category concept. Further preferably, the textual representation further includes, for each of a plurality of subcategories under each category, at least one of a respective subcategory title and a respective subcategory concept.

### Detailed Description of Certain Method Embodiments

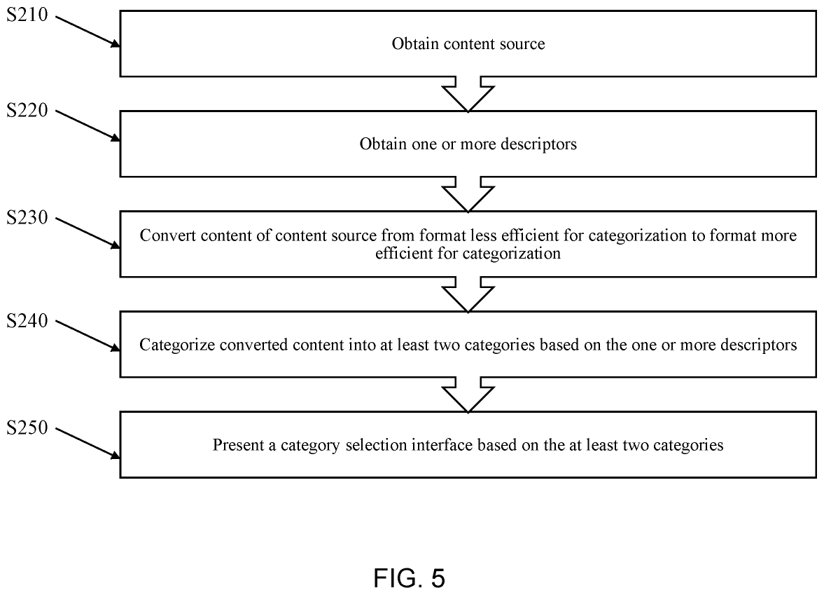

Referring now to FIG. 5, aspects of an example method of an other preferred embodiment of the present general inventive concept are illustrated. References in FIG. 5 made to system components and features can be understood to refer to the elements in FIGS. 1-4 and their descriptions herein, but also or alternatively to corresponding components of other example systems by which the method can be implemented.

Accordingly, in other preferred embodiments of the present general inventive concept, a method of facilitating access to audiovisual content includes obtaining a content source (S210); obtaining one or more descriptors (S220); converting content of the content source from a format less efficient for categorization to a format more efficient for categorization (S230); categorizing the converted content into at least two categories based on the one or more descriptors (S240); and presenting a category selection interface based on the at least two categories (S250).

Further in other preferred embodiments of the present general inventive concept, converting the content includes utilizing one or more of an artificial intelligence conversion algorithm, a transcription algorithm, a description algorithm, and user interaction. In certain embodiments, utilizing the artificial intelligence conversion algorithm includes learning by human intervention to enhance accuracy of conversion. In certain embodiments, utilizing the transcription algorithm includes transcribing audio from the content into a textual transcription. In certain embodiments, utilizing the description algorithm includes summarizing video from the content into a textual description.

Further in other preferred embodiments of the present general inventive concept, the method further comprises categorizing the converted content into at least two subcategories under at least one of the at least two categories (S242).

Further in other preferred embodiments of the present general inventive concept, categorizing the converted content includes utilizing one or more of an artificial intelligence categorization algorithm, a topic extraction algorithm, a speaker diarization algorithm, a semantic web technology algorithm, and user interaction. In certain embodiments, utilizing the artificial intelligence categorization algorithm includes learning by human intervention to enhance accuracy of categorization.

In certain embodiments, utilizing the artificial intelligence categorization algorithm includes creating a respective vector for one or more portions of the converted content, inputting each vector into a recurrent neural network to determine a respective numerical value associated with each vector, determining breakpoints from the numerical values, and establishing the breakpoints as divisions between the categories.

In certain embodiments, utilizing the topic extraction algorithm includes inputting one or more portions of the converted content into a meaning vector space to determine meaning vectors for each portion, and inputting the meaning vectors into a recurrent neural network to establish start and stop points of the converted content for each of a plurality of topics.

In certain embodiments, utilizing the semantic web technology algorithm includes inputting one or more portions of the converted content into a titling modeler to determine titles for each portion, and presenting the category selection interface includes presenting one or more of the titles.

In certain embodiments, the one or more of the descriptors includes at least one of one or more taxonomies, and the method further comprises, when the one or more taxonomies includes a speaker taxonomy, tagging and storing for each speaker associated with the content a respective profile for the speaker (S244), and further comprises, when the one or more taxonomies includes a topic taxonomy, tagging and storing for each topic associated with the content a respective profile for the topic (S246).

Preferably, the method further comprises, when the one or more taxonomies includes a topic taxonomy, utilizing one or more of the artificial intelligence categorization algorithm and the topic extraction algorithm.

Preferably, the method further comprises, when the one or more taxonomies includes a speaker taxonomy, utilizing the speaker diarization algorithm.

Further in other preferred embodiments of the present general inventive concept, the selection interface includes an actionable table of contents for the content. In certain embodiments, presenting the table of contents includes at least one of summarizing and contextualizing the content. In certain embodiments, presenting the table of contents includes enabling a user to at least one of browse and search the content by the one or more descriptors. In certain embodiments, presenting the table of contents includes enabling a user to share at least a portion of each of the at least two categories with another user. In certain embodiments, presenting the table of contents includes enabling a user to provide feedback regarding the table of contents. Preferably, the method further comprises using the feedback to train the system to apply the feedback in subsequent processing.

In certain embodiments, presenting the table of contents includes, for each category, presenting at least one of a respective category title and a respective category concept, each of which can be selected to transport presentation of the content to a corresponding respective presentation category timepoint. Preferably, presenting the table of contents further includes, for each of a plurality of subcategories under each category, presenting at least one of a respective subcategory title and a respective subcategory concept, each of which can be selected to transport presentation of the content to a corresponding respective presentation subcategory timepoint.

In certain embodiments, presenting the table of contents includes presenting a textual representation of the content, and as the content is presented, during each content presentation timeframe corresponding to a respective portion of the textual representation, the presentation of the respective portion of the textual representation is enhanced relative to other portions of the textual representation.

### Illustrative Example

Referring again to FIG. 3, an illustrative example is depicted, to further describe the relationships among the inventive concepts discussed and described herein. The illustrative example is in all aspects non-limiting, such that the specific elements, features, and functions described are each merely one of many additional or alternate possibilities for myriad embodiments encompassed by the general inventive concept.

In the illustrative example, the content 106 may be audio content 108 associated with, for example, a panel discussion regarding environmental problems or concerns. The user 120 may assign the speaker taxonomy 138, the topic taxonomy 140, and the one or more attributes 142 to the audio content 108. The speaker taxonomy 138 may include, for example, speakers John Doe, Amy Smith, and Michael Williams. The topic taxonomy 140 may include, for example, a first topic of acid rain and a second topic of water pollution. The one or more attributes 142 may include, for example, a length of time a singular user is speaking (e.g., between 10 seconds and 1 minute). It should be appreciated that the length of time can be any timeframe and is not limited to the illustrative examples provided herein.

The analysis engine 114 may utilize artificial intelligence, topic extraction, speaker diarization, semantic web, and/or user interaction technologies to generate the actionable table of contents 118.

The first section 124 of the actionable table of contents 118 may be associated with a first topic 126 (e.g., the acid rain topic), a first speaker 128 (e.g., John Doe), a second speaker 130 (e.g., Amy Smith), and an attribute 146 (e.g., the timeframe between 10 seconds and 1 minute). As such, the first section 124 would include a portion of the content 106 in which Amy Smith is speaking about acid rain for a timeframe between 10 seconds and 1 minute and would also include another portion of the content 106 in which John Doe is speaking about acid rain for a time frame between 10 seconds and 1 minute.

The second section 132 of the actionable table of contents 118 may be associated with a second topic 134 (e.g., the water pollution topic), the first speaker 128 (e.g., John Doe), a third speaker 136 (e.g., Michael Williams), and the attribute 146 (e.g., the time frame between 10 seconds and 1 minute). As such, the second section 132 would include a portion of the content 106 in which John Doe is speaking about water pollution for a timeframe between 10 seconds and 1 minute and would also include another portion of the content 106 in which Michael Williams is speaking about water pollution for a timeframe between 10 seconds and 1 minute.

The first section 124 and the second section 132 may be further sub-divided into chapters. The chapters are used for organizing sections according to a topic. As an example, the first section 124 may include a first chapter associated with the portion of the content 106 in which Amy Smith is speaking about acid rain for the timeframe between 10 seconds and 1 minute, and may include a second chapter associated with the portion of the content 106 in which John Doe is speaking about acid rain for the timeframe between 10 seconds and 1 minute. As another example, the second section 132 may include a first chapter associated with the portion of the content 106 in which John Doe is speaking about water pollution for the timeframe between 10 seconds and 1 minute. The second section 132 may also include a second chapter associated with the other portion of the content 106 in which Michael Williams is speaking about water pollution for the timeframe between 10 seconds and 1 minute. The first section 124 and the second section 132 may be further divided or further categorized in other ways.

### Illustrative Systems, Devices, Operating Systems, and Additional Methods

A basic configuration 232 of a computing device 222 (such as the computing device 102 of FIG. 1) is illustrated in FIG. 4 by those components within the inner dashed line. In the basic configuration 232 of the computing device 222, the computing device 222 includes a processor 234 and a system memory 224. The terms “processor” and “central processing unit” or “CPU” are used interchangeably herein. In some examples, the computing device 222 may include one or more processors and the system memory 224. A memory bus 244 is used for communicating between the one or more processors 234 and the system memory 224.

Depending on the desired configuration, the processor 234 may be of any type, including, but not limited to, a microprocessor (μP), a microcontroller (μC), and a digital signal processor (DSP), or any combination thereof. In examples, the microprocessor may be AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s).

Further, the processor 234 may include one more levels of caching, such as a level cache memory 236, a processor core 238, and registers 240, among other examples. The processor core 238 may include an arithmetic logic unit (ALU), a floating point unit (FPU), and/or a digital signal processing core (DSP Core), or any combination thereof. A memory controller 242 may be used with the processor 234, or, in some implementations, the memory controller 242 may be an internal part of the memory controller 242.

Depending on the desired configuration, the system memory 224 may be of any type, including, but not limited to, volatile memory (such as RAM), and/or non-volatile memory (such as ROM, flash memory, etc.), or any combination thereof. The system memory 224 includes an operating system 226, one or more engines, such as an analysis engine 114, and program data 230. In some embodiments, the analysis engine 114 may be an application, a software program, a service, or a software platform, as described infra. The system memory 224 may also include a storage engine 228 that may store any information/data disclosed herein.

The operating system 226 may be a highly fault tolerant, scalable, and secure system such as: Apple Macintosh OS X (Server); AT&T Plan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millennium/NT/Vista/XP (Server), and/or the like. The operating system 226 may be one specifically optimized to be run on a mobile computing device (e.g., the computing device 102), such as iOS, Android, Windows Phone, Tizen, Symbian, and/or the like.

As explained supra, the GUI 104 of the computing device 102 may provide a baseline and means of accessing and displaying information graphically to users. The GUI 104 may include Apple Macintosh Operating System's Aqua, IBM's OS/2, Microsoft's Windows 2000/2003/3.1/95/98/CE/Millennium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, or Yahoo! User Interface, any of which may be used.

Additionally, a web browser component (not shown) is a stored program component that is executed by the CPU. The web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices (e.g., the computing device 102 of FIG. 1).

A web browser may communicate to and/or with other components in a component collection, including itself, and/or facilities of the like. Most frequently, the web browser communicates with information servers, operating systems (such as the operating system 226), integrated program components (e.g., plug-ins), and/or the like; e.g., it may contain, communicate, generate, obtain, and/or provide program component, system, user, and/or data communications, requests, and/or responses. Of course, in place of a web browser and an information server, a combined application may be developed to perform similar functions of both. The combined application would similarly affect the obtaining and the provision of information to users, user agents, and/or the like from the enabled nodes of the present invention.

Moreover, the computing device 222 may have additional features or functionality, and additional interfaces to facilitate communications between the basic configuration 232 and any desired devices and interfaces. For example, a bus/interface controller 248 is used to facilitate communications between the basic configuration 232 and data storage devices 246 via a storage interface bus 250. The data storage devices 246 may be one or more removable storage devices 252, one or more non-removable storage devices 254, or a combination thereof. Examples of the one or more removable storage devices 252 and the one or more non-removable storage devices 254 include magnetic disk devices (such as flexible disk drives and hard-disk drives (HDD)), optical disk drives (such as compact disk (CD) drives or digital versatile disk (DVD) drives), solid state drives (SSD), and tape drives, among others.

In some embodiments, an interface bus 256 facilitates communication from various interface devices (e.g., one or more output devices 280, one or more peripheral interfaces 272, and one or more communication devices 264) to the basic configuration 232 via the bus/interface controller 256. Some of the one or more output devices 280 include a graphics processing unit 278 and an audio processing unit 276, which are configured to communicate to various external devices, such as a display or speakers, via one or more A/V ports 274.

The one or more peripheral interfaces 272 may include a serial interface controller 270 or a parallel interface controller 266, which are configured to communicate with external devices, such as input devices (e.g., a keyboard, a mouse, a pen, a voice input device, or a touch input device, etc.) or other peripheral devices (e.g., a printer or a scanner, etc.) via one or more I/O ports 268.

Further, the one or more communication devices 264 may include a network controller 258, which is arranged to facilitate communication with one or more other computing devices 262 over a network communication link via one or more communication ports 260. The one or more other computing devices 262 include servers (such as the server 122 of FIG. 1), the database, mobile devices, and comparable devices.

The network communication link is an example of a communication media. The communication media are typically embodied by the computer-readable instructions, data structures, program modules, or other data in a modulated data signal, such as a carrier wave or other transport mechanism, and include any information delivery media. A “modulated data signal” is a signal that has one or more of its characteristics set or changed in such a manner as to encode information in the signal. By way of example, and not limitation, the communication media may include wired media (such as a wired network or direct-wired connection) and wireless media (such as acoustic, radio frequency (RF), microwave, infrared (IR), and other wireless media). The term “computer-readable media,” as used herein, includes both storage media and communication media.

It should be appreciated that the system memory 224, the one or more removable storage devices 252, and the one or more non-removable storage devices 254 are examples of the computer-readable storage media. The computer-readable storage media is a tangible device that can retain and store instructions (e.g., program code) for use by an instruction execution device (e.g., the computing device 222). Any such, computer storage media is part of the computing device 222.

The computer readable storage media/medium can be a tangible device that can retain and store instructions for use by an instruction execution device. The computer readable storage media/medium may be, for example, but is not limited to, an electronic storage device, a magnetic storage device, an optical storage device, an electromagnetic storage device, and/or a semiconductor storage device, or any suitable combination of the foregoing. Anon-exhaustive list of more specific examples of the computer readable storage media/medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and/or a mechanically encoded device (such as punch-cards or raised structures in a groove having instructions recorded thereon), and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

The computer-readable instructions are provided to the processor 234 of a general purpose computer, special purpose computer, or other programmable data processing apparatus (e.g., the computing device 222) to produce a machine, such that the instructions, which execute via the processor 234 of the computer or other programmable data processing apparatus, create means for implementing the functions/acts specified in the block diagram blocks. These computer-readable instructions are also stored in a computer-readable storage medium that can direct a computer, a programmable data processing apparatus, and/or other devices to function in a particular manner, such that the computer-readable storage medium having instructions stored therein comprises an article of manufacture including instructions, which implement aspects of the functions/acts specified in the block diagram blocks.

The computer-readable instructions (e.g., the program code) are also loaded onto a computer (e.g. the computing device 222), another programmable data processing apparatus, or another device to cause a series of operational steps to be performed on the computer, the other programmable apparatus, or the other device to produce a computer implemented process, such that the instructions, which execute on the computer, the other programmable apparatus, or the other device, implement the functions/acts specified in the block diagram blocks.

Computer readable program instructions described herein can also be downloaded to respective computing/processing devices from a computer readable storage medium or to an external computer or external storage device via a network (e.g., the Internet, a local area network, a wide area network, and/or a wireless network). The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer/computing device, partly on the user's computer/computing device, as a stand-alone software package, partly on the user's computer/computing device and partly on a remote computer/computing device or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Another embodiment of the invention provides a method that performs the process steps on a subscription, advertising, and/or fee basis. That is, a service provider can offer to assist in the method steps of generating an actionable table of contents. In this case, the service provider can create, maintain, and/or support, etc. a computer infrastructure that performs the process steps for one or more customers. In return, the service provider can receive payment from the customer(s) under a subscription and/or fee agreement, and/or the service provider can receive payment from the sale of advertising content to one or more third parties.

### Additional Implementations

Aspects of the present invention are described herein with reference to block diagrams of methods, computer systems, and computing devices according to embodiments of the invention. It will be understood that each block and combinations of blocks in the diagrams, can be implemented by the computer readable program instructions. The block diagrams illustrate the architecture, functionality, and operation of possible implementations of computer systems, methods, and computing devices according to various embodiments of the present invention. In this regard, each block in the block diagrams may represent a module, a segment, or a portion of executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block and combinations of blocks can be implemented by special purpose hardware-based systems that perform the specified functions or acts or carry out combinations of special purpose hardware and computer instructions.

While the present general inventive concept has been illustrated by description of several example embodiments, and while the illustrative embodiments have been described in detail, it is not the intention of the applicant to restrict or in any way limit the scope of the general inventive concept to such descriptions and illustrations. Instead, the descriptions, drawings, and claims herein are to be regarded as illustrative in nature, and not as restrictive, and additional embodiments will readily appear to those skilled in the art upon reading the above description and drawings. Additional modifications will readily appear to those skilled in the art. Accordingly, departures may be made from such details without departing from the spirit or scope of applicant's general inventive concept.

What is claimed is:

1. A system for facilitating access to audiovisual content, comprising:
a content obtaining unit configured to obtain a content source;
a descriptor obtaining unit configured to obtain one or more descriptors;
a conversion unit configured to convert content of the content source from a format less efficient for categorization to a format more efficient for categorization;
a categorization unit configured to categorize the converted content into at least two categories based on the one or more descriptors; and
a presentation unit configured to present a category selection interface based on the at least two categories.

2. The system of claim 1, wherein the content source is a computer-readable file containing one or more of audio content, video content, and audiovisual content.

3. The system of claim 1, wherein the one or more descriptors includes one or more taxonomies.

4. The system of claim 3, wherein the one or more taxonomies includes one or more of a speaker taxonomy and a topic taxonomy.

5. The system of claim 1, wherein the one or more descriptors includes one or more attributes associated with the content.

6. The system of claim 5, wherein the one or more attributes includes one or more of a timeframe and an amount of time.

7. The system of claim 1, wherein to convert the content, the conversion unit utilizes one or more of an artificial intelligence conversion algorithm, a transcription algorithm, a description algorithm, and user interaction.

8. The system of claim 1, wherein the categorization unit further categorizes the converted content into at least two subcategories under at least one of the at least two categories.

9. The system of claim 1, wherein to categorize the converted content, the categorization unit utilizes one or more of an artificial intelligence categorization algorithm, a topic extraction algorithm, a speaker diarization algorithm, a semantic web technology algorithm, and user interaction.

10. The system of claim 9, wherein the artificial intelligence categorization algorithm includes an option for learning by human intervention to enhance accuracy of categorization.

11. The system of claim 1, wherein the selection interface includes an actionable table of contents for the content.

12. The system of claim 11, wherein the table of contents includes, for each category, at least one of a respective category title and a respective category concept, each of which can be selected to transport presentation of the content to a corresponding respective presentation category timepoint.

13. The system of claim 11, wherein the table of contents includes a textual representation of the content, and as the content is presented, during each content presentation timeframe corresponding to a respective portion of the textual representation, the presentation of the respective portion of the textual representation is enhanced relative to other portions of the textual representation.

14. A method of facilitating access to audiovisual content, comprising:
obtaining a content source;
obtaining one or more descriptors;
converting content of the content source from a format less efficient for categorization to a format more efficient for categorization;
categorizing the converted content into at least two categories based on the one or more descriptors; and
presenting a category selection interface based on the at least two categories.

15. The method of claim 14, wherein converting the content includes utilizing one or more of an artificial intelligence conversion algorithm, a transcription algorithm, a description algorithm, and user interaction.

16. The method of claim 14, further comprising categorizing the converted content into at least two subcategories under at least one of the at least two categories.

17. The method of claim 14, wherein categorizing the converted content includes utilizing one or more of an artificial intelligence categorization algorithm, a topic extraction algorithm, a speaker diarization algorithm, a semantic web technology algorithm, and user interaction.

18. The method of claim 17, wherein utilizing the artificial intelligence categorization algorithm includes creating a respective vector for one or more portions of the converted content, inputting each vector into a recurrent neural network to determine a respective numerical value associated with each vector, determining breakpoints from the numerical values, and establishing the breakpoints as divisions between the categories.

19. The method of claim 17, wherein utilizing the topic extraction algorithm includes inputting one or more portions of the converted content into a meaning vector space to determine meaning vectors for each portion, and inputting the meaning vectors into a deep neural network to select one or more of a plurality of topics.

20. The method of claim 17, wherein utilizing the semantic web technology algorithm includes inputting one or more portions of the converted content into a titling modeler to determine titles for each portion, and presenting the category selection interface includes presenting one or more of the titles.
